(19) United States
(12) Patent Application Publication
(10) Pub. No.: US 2025/0088328 A1
(43) Pub. Date: Mar. 13, 2025

(54) METHODS AND APPARATUSES FOR SIDELINK POSITIONING REFERENCE SIGNAL TRANSMISSION

(71) Applicant: Lenovo (Beijing) Limited, Beijing (CN)

(72) Inventors: Xiaodong Yu, Beijing (CN); Haipeng Lei, Beijing (CN); Zhennian Sun, Beijing (CN); Xin Guo, Beijing (CN)

(73) Assignee: Lenovo (Beijing) Limited, Beijing (CN)

(21) Appl. No.: 18/720,382

(22) PCT Filed: Dec. 17, 2021
(86) PCT No.: PCT/CN2021/139260

§ 371 Date: Jun. 14, 2024

(51) Int. Cl. H04L 5/00; H04W 72/0446; H04W 72/25

(52) U.S. Cl. CPC H04L 5/0051; H04W 72/25; H04W 72/0446

(57) ABSTRACT

Embodiments of the present disclosure relate to methods and apparatuses for sidelink positioning reference signal (SL-PRS) transmission. According to an embodiment of the present disclosure, a user equipment (UE) can include: a transmitter configured to: transmit sidelink control information (SCI), wherein the SCI indicates a sidelink resource for transmitting a SL-PRS; and transmit the SL-PRS based on the SCI; a receiver, and a processor coupled to the transmitter and the receiver.

### TECHNICAL FIELD

Embodiments of the present application generally relate to wireless communication technology, and especially to methods and apparatuses for sidelink (SL) positioning reference signal (SL-PRS) transmission.

### BACKGROUND

Vehicle to everything (V2X) has been introduced into 3GPP 5G wireless communication technology. In terms of a channel structure of V2X communication, a direct link between two user equipment (UEs) is called a sidelink. A sidelink is a long-term evolution (LTE) feature introduced in 3GPP Release 12, and enables a direct communication between proximal UEs, in which data does not need to go through a base station (BS) or a core network.

SL positioning refers to transmitting PRS over SL, which can operate independently of network or radio access technology (RAT) coverage and provide a new positioning method that fits new network use cases. Currently, details regarding how to transmit a SL-PRS have not been discussed in 3GPP 5G and/or NR technology yet.

### SUMMARY OF THE APPLICATION

Embodiments of the present application at least provide technical solutions for SL-PRS transmission.

According to some embodiments of the present application, a method performed by a UE may include: transmitting sidelink control information (SCI), wherein the SCI indicates at least one sidelink resource for transmitting a SL-PRS; and transmitting the SL-PRS based on the SCI.

In some embodiments of the present application, the method may further include: receiving at least one of: configuration information indicating whether a resource pool used for data transmission can be used for transmitting the SL-PRS: a first indication indicating whether at least one slot of the resource pool can be used for transmitting the SL-PRS: or a second indication indicating whether a RB of the resource pool can be used for transmitting the SL-PRS.

In some embodiments of the present application, the method may further include: receiving a configuration information including a first SL-PRS configuration and a second SL-PRS configuration, wherein the first SL-PRS configuration is associated with transmission of the SL-PRS on a physical sidelink shared channel (PSSCH) and the second SL-PRS configuration is associated with transmission of the SL-PRS on a physical sidelink feedback channel (PSFCH); and wherein the SCI includes a 1-bit indication indicating that either the first SL-PRS configuration or the second SL-PRS configuration is used for transmitting the SL-PRS.

In some embodiments of the present application, the SCI includes a 1-bit indication indicating that the SL-PRS is transmitted on either a PSSCH or a PSFCH.

In some embodiments of the present application, the method may further include: receiving configuration information indicating two of the following three configurations: the SL-PRS can be transmitted on a PSSCH, the SL-PRS can be transmitted on a PSFCH, and the SL-PRS can be transmitted on both the PSSCH and the PSFCH, and wherein the SCI includes a 1-bit indication indicating one of the two configurations is used for transmitting the SL-PRS.

In some embodiments of the present application, the SCI includes a 2-bit indication indicating that: the SL-PRS is transmitted on a PSSCH: the SL-PRS is transmitted on a PSFCH: or the SL-PRS is transmitted on both the PSSCH and the PSFCH.

In some embodiments of the present application, the method may further include: receiving configuration information per resource pool indicating that the SL-PRS can be transmitted on either a PSSCH or a PSFCH: wherein in the case that the configuration information indicates that the SL-PRS can be transmitted on the PSSCH, the SCI includes a 1-bit indication indicating whether data or the SL-PRS is transmitted on the PSSCH; and wherein in the case that the configuration information indicates that the SL-PRS can be transmitted on the PSFCH, the SCI includes a 1-bit indication indicating whether feedback information or the SL-PRS is transmitted on the PSFCH.

In some embodiments of the present application, the method may further include: receiving configuration information per resource pool indicating that the SL-PRS can be transmitted on at least one of a PSSCH or a PSFCH; and wherein the SCI includes a 2-bit indication indicating that the SL-PRS is transmitted on the PSSCH, the PSFCH or both.

In some embodiments of the present application, the method may further include: receiving DCI, and wherein the DCI indicates the at least one sidelink resource for transmitting the SL-PRS; and generating the SCI based on the DCI.

In some embodiments of the present application, the method may further include: receiving a configuration information including a first SL-PRS configuration and a second SL-PRS configuration before receiving the DCI, wherein the first SL-PRS configuration indicates that the SL-PRS can be transmitted on a PSSCH and the second SL-PRS configuration indicates that the SL-PRS can be transmitted on a PSFCH; and wherein each of the DCI and the SCI includes a 1-bit indication indicating either the first SL-PRS configuration or the second SL-PRS configuration is applied for transmitting the SL-PRS.

In some embodiments of the present application, each of the DCI and the SCI includes a 1-bit indication indicating that the SL-PRS is transmitted on either a PSSCH or a PSFCH.

In some embodiments of the present application, the method may further include: receiving configuration information before receiving the DCI, and the configuration information indicates two of the following three configurations: the SL-PRS can be transmitted on a PSSCH, the SL-PRS can be transmitted on a PSFCH, and the SL-PRS can be transmitted on both the PSSCH and the PSFCH, and wherein each of the DCI and the SCI includes a 1-bit indication indicating one of the two configurations is used for transmitting the SL-PRS.

In some embodiments of the present application, each of the DCI and the SCI includes a 2-bit indication indicating that: the SL-PRS is transmitted on a PSSCH; the SL-PRS is transmitted on a PSFCH; or the SL-PRS is transmitted on both the PSSCH and the PSFCH.

In some embodiments of the present application, the method may further include: receiving configuration information before receiving the DCI, and the configuration information indicates that the SL-PRS can be transmitted on either a PSSCH or a PSFCH; wherein in the case that the configuration information indicates that the SL-PRS can be transmitted on the PSSCH, each of the DCI and the SCI includes a 1-bit indication indicating whether data or the SL-PRS is transmitted on the PSSCH; and wherein in the case that the configuration information indicates that the SL-PRS can be transmitted on the PSFCH, each of the DCI and the SCI includes a 1-bit indication indicating whether feedback information or the SL-PRS is transmitted on the PSFCH.

In some embodiments of the present application, the method may further include: receiving configuration information per resource pool before receiving the DCI, and the configuration information indicates that the SL-PRS can be transmitted on at least one of a PSSCH or a PSFCH; and wherein each of the DCI and the SCI includes a 2-bit indication indicating that the SL-PRS is transmitted on the PSSCH, the PSFCH or both.

In some embodiments of the present application, the SCI includes a first stage SCI and a second stage SCI.

According to some embodiments of the present application, a method performed by a UE may include: receiving SCI, wherein the SCI indicates at least one sidelink resource for transmitting a SL-PRS; and receiving the SL-PRS based on the SCI.

In some embodiments of the present application, the method may further include: receiving at least one of: configuration information indicating whether a resource pool used for data transmission can be used for transmitting the SL-PRS; a first indication indicating whether at least one slot of the resource pool can be used for transmitting the SL-PRS: or a second indication indicating whether a RB of the resource pool can be used for transmitting the SL-PRS.

In some embodiments of the present application, the method may further include: receiving a configuration information including a first SL-PRS configuration and a second SL-PRS configuration, wherein the first SL-PRS configuration is associated with transmission of the SL-PRS on a PSSCH and the second SL-PRS configuration is associated with transmission of the SL-PRS on a PSFCH; and wherein the SCI includes a 1-bit indication indicating that either the first SL-PRS configuration or the second SL-PRS configuration is used for transmitting the SL-PRS.

In some embodiments of the present application, the SCI includes a 1-bit indication indicating that the SL-PRS is transmitted on either a PSSCH or a PSFCH.

In some embodiments of the present application, the method may further include: receiving configuration information indicating two of the following three configurations: the SL-PRS can be transmitted on a PSSCH, the SL-PRS can be transmitted on a PSFCH, and the SL-PRS can be transmitted on both the PSSCH and the PSFCH, and wherein the SCI includes a 1-bit indication indicating one of the two configurations is used for transmitting the SL-PRS.

In some embodiments of the present application, the SCI includes a 2-bit indication indicating that: the SL-PRS is transmitted on a PSSCH: the SL-PRS is transmitted on a PSFCH: or the SL-PRS is transmitted on both the PSSCH and the PSFCH.

In some embodiments of the present application, the method may further include: receiving configuration information per resource pool indicating that the SL-PRS can be transmitted on either a PSSCH or a PSFCH: wherein in the case that the configuration information indicates that the SL-PRS can be transmitted on the PSSCH, the SCI includes a 1-bit indication indicating whether data or the SL-PRS is transmitted on the PSSCH; and wherein in the case that the configuration information indicates that the SL-PRS can be transmitted on the PSFCH, the SCI includes a 1-bit indication indicating whether feedback information or the SL-PRS is transmitted on the PSFCH.

In some embodiments of the present application, the method may further include: receiving configuration information per resource pool indicating that the SL-PRS can be transmitted on at least one of a PSSCH or a PSFCH; and wherein the SCI includes a 2-bit indication indicating that the SL-PRS is transmitted on the PSSCH, the PSFCH or both.

In some embodiments of the present application, wherein the SCI includes a first stage SCI and a second stage SCI.

According to some embodiments of the present application, a method performed by a network entity may include transmitting DCI, wherein the DCI indicates at least one sidelink resource for transmitting a SL-PRS.

In some embodiments of the present application, the method may further include: transmitting at least one of: configuration information indicating whether a resource pool used for data transmission can be used for transmitting the SL-PRS: a first indication indicating whether at least one slot of the resource pool can be used for transmitting the SL-PRS: or a second indication indicating whether a RB of the resource pool can be used for transmitting the SL-PRS.

In some embodiments of the present application, the method may further include: transmitting a configuration information including a first SL-PRS configuration and a second SL-PRS configuration before transmitting the DCI, wherein the first SL-PRS configuration is associated with transmission of the SL-PRS on a PSSCH and the second SL-PRS configuration is associated with transmission of the SL-PRS on a PSFCH; and wherein the DCI includes a 1-bit indication indicating either the first SL-PRS configuration or the second SL-PRS configuration to be used for transmitting the SL-PRS.

In some embodiments of the present application, the DCI includes a 1-bit indication indicating that the SL-PRS is transmitted on either a PSSCH or a PSFCH.

In some embodiments of the present application, the method may further include: transmitting configuration information before transmitting the DCI, and the configuration information indicates two of the following three configurations: the SL-PRS can be transmitted on a PSSCH, the SL-PRS can be transmitted on a PSFCH, and the SL-PRS can be transmitted on both the PSSCH and the PSFCH, and wherein the DCI includes a 1-bit indication indicating one of the two configurations to be used for transmitting the SL-PRS.

In some embodiments of the present application, the DCI includes a 2-bit indication indicating that: the SL-PRS is transmitted on a PSSCH: the SL-PRS is transmitted on a PSFCH: or the SL-PRS is transmitted on both the PSSCH and the PSFCH.

In some embodiments of the present application, the method may further include: transmitting configuration information before transmitting the DCI, and the configuration information indicates that the SL-PRS can be transmitted on either a PSSCH or a PSFCH: wherein in the case that the configuration information indicates that the SL-PRS can be transmitted on the PSSCH, the DCI includes 1-bit indication indicating whether data or the SL-PRS to be transmitted on the PSSCH; and wherein in the case that the configuration information indicates that the SL-PRS can be transmitted on the PSFCH, the DCI includes 1-bit indication indicating whether feedback information or the SL-PRS to be transmitted on the PSFCH.

In some embodiments of the present application, the method may further include: transmitting configuration information per resource pool before transmitting the DCI, and the configuration information indicates that the SL-PRS can be transmitted on at least one of a PSSCH or a PSFCH; and wherein the DCI includes a 2-bit indication indicating whether the SL-PRS is transmitted on the PSSCH, the PSFCH or both.

According to some embodiments of the present application, a UE may include: a transmitter configured to: transmit, wherein the SCI indicates at least one sidelink resource for transmitting a SL-PRS; and transmit the SL-PRS based on the SCI; a receiver; and a processor coupled to the transmitter and the receiver.

According to some embodiments of the present application, a UE may include: a receiver configured to: receive SCI, wherein the SCI indicates at least one sidelink resource for transmitting a SL-PRS; and receive the SL-PRS based on the SCI; a transmitter; and a processor coupled to the transmitter and the receiver.

According to some embodiments of the present application, a network entity may include: a transmitter configured to: transmit DCI, wherein the DCI indicates at least one sidelink resource for transmitting a SL-PRS; a receiver; and a processor coupled to the transmitter and the receiver.

Embodiments of the present application provide technical solutions for SL-PRS transmission, which include but are not limited to apparatuses and methods for determining and informing the resource used for SL-PRS transmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates two exemplary SL positioning architectures according to some embodiments of the present application;

FIG. 3 illustrates two exemplary sidelink slot patterns according to some embodiments of the present application;

FIG. 4 illustrates two exemplary sidelink slot patterns according to some other embodiments of the present application;

FIG. 5 is a flow chart illustrating an exemplary method for SL-PRS transmission according to some embodiments of the present application;

FIG. 6 illustrates twelve exemplary SL-PRS patterns in PSSCH according to some embodiments of the present application;

FIG. 7 illustrate exemplary SL-PRS transmissions for four UEs according to some embodiments of the present application;

FIGS. 8A-8D illustrate four exemplary PRS patterns in PSSCH according to some embodiments of the present application;

FIG. 9 illustrates two exemplary SL-PRS patterns in PSFCH according to some embodiments of the present application;

FIGS. 10A-10C illustrate exemplary SL-PRS transmission according to some embodiments of the present application:

FIG. 11 is a flow chart illustrating an exemplary method for SL-PRS transmission according to some other embodiments of the present application;

FIG. 12 is a flow chart illustrating an exemplary method for SL-PRS transmission according to some other embodiments of the present application;

FIG. 13 is a flow chart illustrating an exemplary method for SL-PRS transmission according to some other embodiments of the present application; and

FIG. 14 illustrates a simplified block diagram of an exemplary apparatus for SL-PRS transmission according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., new radio (NR)). 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

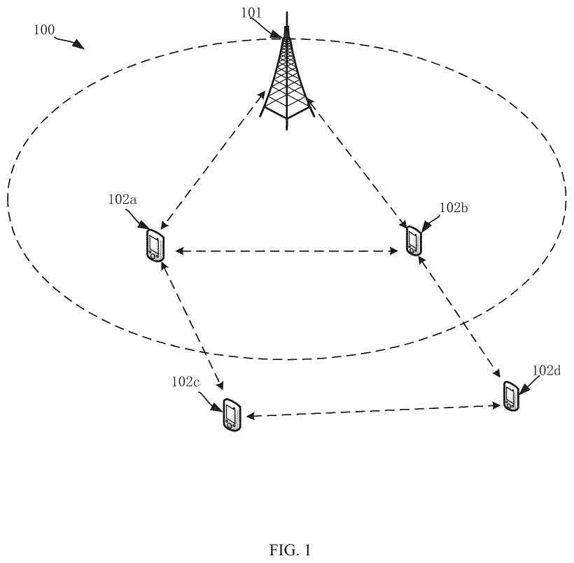

FIG. 1 is a schematic diagram illustrating an exemplary wireless communication system 100 according to some embodiments of the present application.

As shown in FIG. 1, the wireless communication system 100 includes at least one base station (BS) 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

When a location service request is initiated or occurs at a UE, the UE (referred to as target UE or location service (LCS) target UE) needs to know its own position. When the target UE is within a coverage area of a BS or network (i.e., in coverage), the target UE may get positioning information from the BS or network, which is known as Uu positioning or NR Uu positioning. When the target UE is outside a coverage area of any BS or network (i.e., out of coverage), the target UE cannot get positioning information from any BS or network. According to various embodiments of the present disclosure, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL-PRS and doing relevant measurements. The SL anchor UE should have positioning capability, and may be a roadside unit (RSU) or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

In an embodiment, the UE 102a may act as an SL target UE. The UE 102a may select the UE 102b to be an SL anchor UE to assist the UE 102a to acquire its position, which is in the “both in coverage” scenario. Alternatively or additionally, the UE 102a may select the UE 102c to be an SL anchor UE to assist the UE 102a to acquire its position, which is in the “partial coverage” scenario. It should be understood that the UE 102a may alternatively or additionally select other SL anchor UE(s) not shown in FIG. 1.

In an embodiment, the UE 102d may act as an SL target UE. The UE 102d may select the UE 102b to be an SL anchor UE to assist the UE 102d to acquire its position, which is in the “partial coverage” scenario. Alternatively or additionally, the UE 102d may select the UE 102c to be an SL anchor UE to assist the UE 102d to acquire its position, which is in the “both out of coverage” scenario. It should be understood that the UE 102d may alternatively or additionally select other SL anchor UE(s) not shown in FIG. 1. The SL anchor UE(s) selected by the UE 102d may be different from the SL anchor UE(s) selected by the UE 102a.

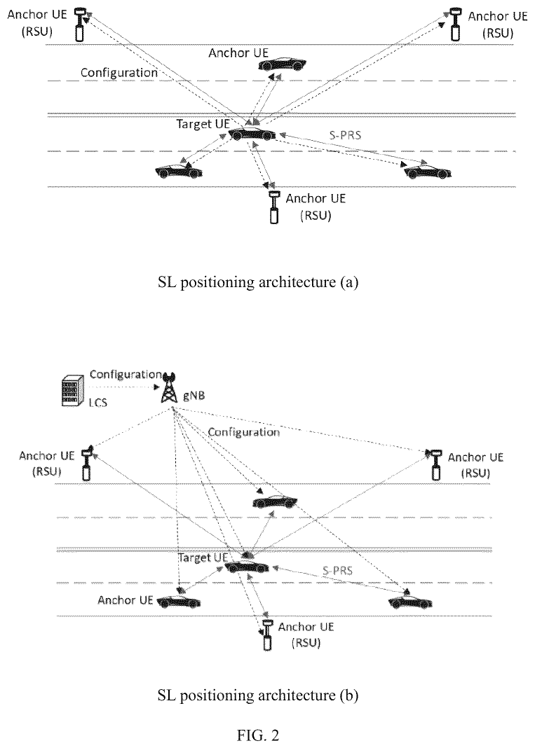

FIG. 2 illustrates two exemplary SL positioning architectures according to some embodiments of the present application. The two exemplary SL positioning architectures may be referred to as SL positioning architecture (a) and SL positioning architecture (b).

In the SL positioning architecture (a), both the target UE and the anchor UEs are out of coverage of the network. In such architecture, the target UE may select six anchor UEs to help the target UE to acquire its position, wherein three anchor UEs are RSUs and the remaining three anchor UEs are vehicle. The target UE may transmit configuration for SL-PRS transmission to each of the anchor UEs, and then transmit the SL-PRS to each of the anchor UEs. Each of the anchor UEs may receive the SL-PRS transmitted from the target UE, and perform measurement of the SL-PRS. The measurement results from the anchor UEs may help to acquire the target UE's position.

In the SL positioning architecture (b), both the target UE and the anchor UEs are in coverage of the network. In such architecture, the target UE may select six anchor UEs to help the target UE to acquire its position, wherein three anchor UEs are RSUs and the remaining three anchor UEs are vehicle. The network entity, e.g., the location service (LCS) or the base station (BS) may transmit configuration for SL-PRS transmission to the target UE and each of the anchor UEs. Then, the target UE may transmit the SL-PRS to each of the anchor UEs. Each of the anchor UEs may receive the SL-PRS transmitted from the target UE, and perform measurement of the SL-PRS. The measurement results from the anchor UEs may help to acquire the target UE's position.

As stated above, in order to perform the SL positioning, the target UE may transmit SL-PRS to an anchor UE. According to draft objection for Rel-18 study item (SI)/work item (WI) on SL positioning, the SL positioning may reuse existing methodologies from sidelink communication. Given this, the SL-PRS may be transmitted based on a slot pattern of the sidelink. The slot pattern of the sidelink may be determined based on a resource pool configuration as specified in 3GPP standard documents.

Although the resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication.

Without loss of generality, this application only illustrates examples where all 14 OFDM symbols (also referred to as symbols) within a sidelink slot are available for sidelink communication.

In addition, the resource pool configuration may also configure the number of sub-channels of a resource pool and the size of a sub-channel (e.g., the number of physical resource blocks (PRBs) included in a sub-channel). The PRB may also be referred to as RB in the embodiments of the present application. For example, as specified in 3GPP standard documents, the number of PRBs included in a sub-channel may be any one of {10, 15, 20, 25, 50, 75, 100}.

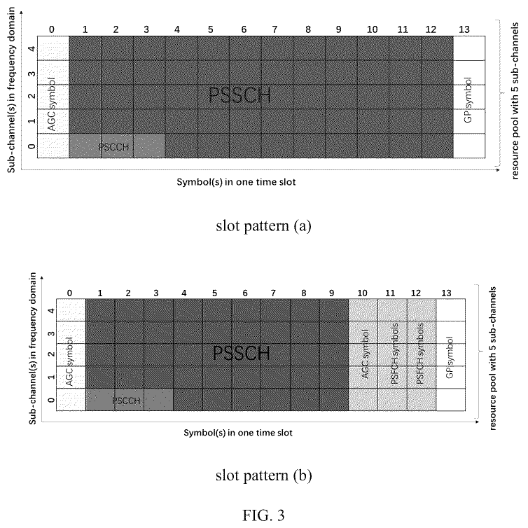

FIG. 3 illustrates two exemplary sidelink slot patterns according to some embodiments of the present application. In the embodiments of FIG. 3, three symbols in one sidelink slot may be used for the PSSCH transmission, and thus the PSCCH may be referred to as 3-symbol PSCCH.

As shown in FIG. 3, the two exemplary sidelink slot patterns may be referred to as slot pattern (a) and slot pattern (b). In the slot pattern (a) and slot pattern (b), one sidelink slot includes 14 OFDM symbols in total (i.e., OFDM symbol #0 to OFDM symbol #13) and five sub-channels in total (i.e., sub-channel #0 to sub-channel #4). OFDM symbol #0 is used for AGC by repeating the first OFDM symbol (i.e., OFDM symbol #1) carrying physical sidelink shared channel (PSSCH) and/or physical sidelink control channel (PSCCH) transmissions. Therefore, the OFDM symbol #0 may be referred to as AGC symbol.

The last available OFDM symbol, i.e., OFDM symbol #13, is always used as a guard symbol (i.e., GP symbol). In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol”, “a PSSCH and/or PSCCH symbol”, or the like.

In the embodiments of FIG. 3, the difference between slot pattern (a) and slot pattern (b) is OFDM Symbol #10 to OFDM symbol #12. Specifically, in slot pattern (a), OFDM Symbol #10 to OFDM symbol #12 are used to carry PSSCH transmissions. However, in slot pattern (b), the hybrid automatic repeat request (HARQ) feedback is enabled for the sidelink slot, then a PSFCH transmission is transmitted in the last second and third available OFDM symbols (i.e., OFDM symbols #11 and #12 as shown in slot pattern (b) in FIG. 2) of the sidelink slot. An OFDM symbol carrying a PSFCH transmission may be named as “a PSFCH OFDM symbol”, “a PSFCH symbol”, or the like. One OFDM symbol right prior to the PSFCH symbol #11 may be used as AGC symbol and may comprise a copy of the PSFCH symbol #11. For example OFDM symbol #10 as shown in slot pattern (b) in FIG. 3 is used as AGC by repeating the PSFCH symbol #11 as shown in slot pattern (b) in FIG. 3.

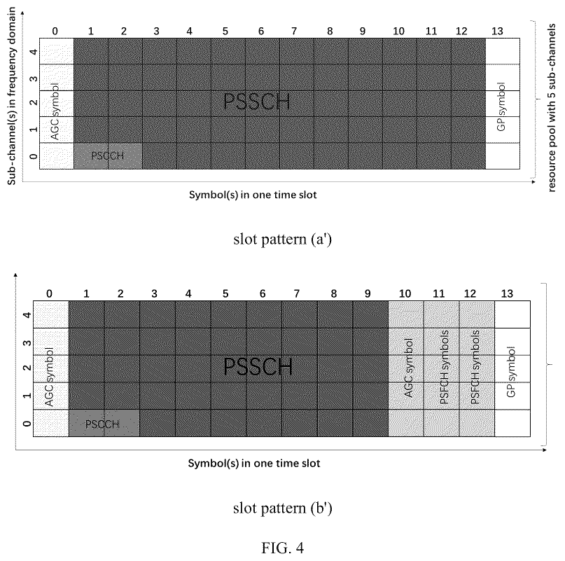

FIG. 4 illustrates two exemplary sidelink slot patterns according to some other embodiments of the present application. As shown in FIG. 4, the two exemplary sidelink slot patterns may be referred to as slot pattern (a′) and slot pattern (b′). The differences between slot pattern (a′) in FIG. 4 and slot pattern (a) in FIG. 3 are that in slot pattern (a′), two symbols (e.g., OFDM symbol #1 and OFDM symbol #2) in one sidelink slot may be used for the PSCCH transmission and OFDM symbol #3 may be completely used for the PSSCH transmission. Similarly, the differences between slot pattern (b′) in FIG. 4 and slot pattern (b) in FIG. 3 are that in slot pattern (b′), two symbols (e.g., OFDM symbol #1 and OFDM symbol #2) in one sidelink slot may be used for the PSCCH transmission and OFDM symbol #3 may be completely used for the PSSCH transmission. The PSSCH in FIG. 4 may be referred to as 2-symbol PSCCH.

The SL-PRS may be transmitted based on the SL slot pattern as shown in FIG. 3 or FIG. 4. However, how to transmit SL-PRS based on the SL slot pattern (e.g., the SL-PRS is transmitted on which resources) and how does the target UE inform the anchor UE the resources for transmitting the SL-PRS have not been discussed vet.

Given this, embodiments of the present application propose methods for SL-PRS transmission, which provide various technical solutions regarding how to transmit SL-PRS based on the SL slot pattern (e.g., the SL-PRS is transmitted on which resources) and how does the target UE inform the anchor UE the resources for transmitting the SL-PRS. More details on embodiments of the present application will be described in the following text in combination with the appended drawings.

According to some embodiments of the present application, a separated resource pool may be configured or indicated to the target UE and the anchor UEs for the SL-PRS transmission.

According to some other embodiments, a resource pool used for data transmission may also be used for the SL-PRS transmission. In such embodiments, a UE (e.g., a target UE or an anchor UE) may receive at least one of:
configuration information indicating whether a resource pool used for data transmission can be used for transmitting the SL-PRS;
a first indication indicating whether at least one slot of the resource pool can be used for transmitting the SL-PRS; or
a second indication indicating whether a resource block (RB) of the resource pool can be used for transmitting the SL-PRS.

The configuration information may be transmitted from a network entity (e.g., a location management function (LMF) entity or a BS). For example, the configuration information may be transmitted by the LMF to the UE via an LTE positioning protocol (LPP) signaling or transmitted by the BS to the UE via a radio resource control (RRC) signaling. The configuration information may be used to enable or disable the existing resource pool for SL-PRS transmission. In other words, the configuration information may be used to indicate whether the SL-PRS transmission within the resource pool is enabled or not. The configuration information can be configured semi-static. That is, in the case that the configuration information enables the existing resource pool for SL-PRS transmission, which means that the resource pool supports both data transmission and SL-PRS transmission. The configuration information can be configured semi-statically.

The first indication may be transmitted from a network entity (e.g., an LMF entity or a BS). For example, the first indication may be transmitted by the LMF to the UE via an LPP signaling or transmitted by the BS to the UE via a RRC signaling. In an embodiment of the present application, the first indication may be included in the resource pool configuration.

In an embodiment of the present application, the first indication may be a sequence of bits (or a bitmap) corresponding to one or more slots of the resource pool, each bit of the sequence of bits indicates whether a corresponding slot can be used for SL-PRS transmission. For example, the first indication may be a “0/1” sequence with the size of 1024 or 10240, which corresponding to 1024 or 10240 slots of the resource pool, a bit with value “0” may indicate a corresponding slot cannot be used for SL-PRS transmission, whereas a bit with value “1” may indicate a corresponding slot can be used for SL-PRS transmission, vice versa.

The second indication may be transmitted from a network entity (e.g., an LMF entity or a BS). For example, the second indication may be transmitted by the LMF to the UE via an LPP signaling or transmitted by the BS to the UE via an RRC signaling. In an embodiment of the present application, the second indication may be included in the resource pool configuration.

In an embodiment of the present application, the second indication may be a sequence of bits (or a bitmap) corresponding to one or more resource blocks (RBs) of the resource pool, each bit of the sequence of bits indicates whether a corresponding RB can be used for SL-PRS transmission (in other words, whether the corresponding RB has resource for SL-PRS transmission). For example, a bit with value “1” represents that the corresponding RB has resource for SL-PRS transmission, whereas a bit with value “0” represents that the corresponding RB having no resource for SL-PRS transmission, vice versa. In some embodiments, the second indication may indicate whether a set of RBs on PSFCH has resource for SL-PRS transmission.

In an embodiment of the present application, the size of the second indication (i.e., the number of bits included in the second indication) may be equal to the number of RBs included in the resource pool. For example, the resource pool may include 100 RBs, and the second indication may be a “0/1” sequence with the size of 100, which corresponding to 100 RBs of the resource pool, a bit with value “1” represents that the corresponding RB has resource for SL-PRS transmission, whereas a bit with value “0” represents that the corresponding RB having no resource for SL-PRS transmission, vice versa.

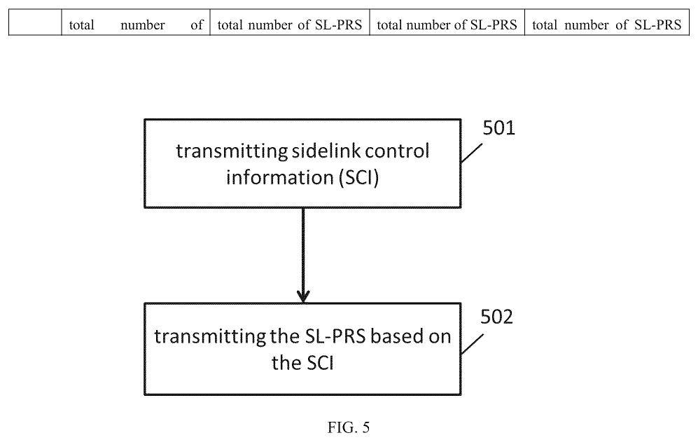

For the resource pool support both the data transmission and the SL-PRS transmission, how to indicate the resource for the SL-PRS transmission may be illustrated with the embodiment in FIG. 5.

FIG. 5 is a flow chart illustrating an exemplary method for SL-PRS transmission according to some embodiments of the present application. The method illustrated in FIG. 5 may be performed by a target UE. The target UE may be a UE at which a location service request is initiated or occurs. In other words, the target UE may be a UE that wants to know its own position. Persons skilled in the art can understand that the method described with respect to the UE can be implemented by other apparatus with the like functions.

In step 501, the target UE may transmit SCI to an anchor UE. The anchor UE may be a UE that participates in SL positioning and helps the target UE to acquire its position, e.g., by sending/receiving SL-PRS and doing relevant measurements. For example, the target UE may be UE 102a as shown in FIG. 1 and the anchor UE may be UE 102b or UE 102c as shown in FIG. 1. In another example, the target UE may be UE 102d as shown in FIG. 1 and the anchor UE may be UE 102b or UE 102c as shown in FIG. 1.

The SCI may indicate at least one sidelink resource for transmitting an SL-PRS. In some embodiments of the present application, a sidelink resource may be a sidelink channel (e.g., a PSSCH or a PSFCH). In such embodiments, at least one sidelink resource may refer to at least one of: a PSSCH or a PSFCH. In some other embodiments of the present application, a sidelink resource may refer to resource elements (REs) and/or RB(s) in a sidelink channel (e.g., a PSSCH or a PSFCH). In such embodiments, at least one sidelink resource may refer to at least one of: REs and/or RB(s) in a PSSCH or REs and/or RB(s) in a PSFCH.

According to some embodiments of the present application, before transmitting the SCI, the target UE may receive at least one of.
the configuration information as stated above, which indicates whether a resource pool used for data transmission can be used for transmitting the SL-PRS;
the first indication as stated above, which indicates whether at least one slot of the resource pool can be used for transmitting the SL-PRS; or
the second indication as stated above, which indicates whether a RB of the resource pool can be used for transmitting the SL-PRS.

After receiving the above configuration information, first indication, and/or second indication, for the resource pool and/or a slot which can be used for SL-PRS transmission, the target UE may transmit the SCI indicating the at least one sidelink resource to the anchor UE.

According to some other embodiments, before transmitting the SCI, the target UE does not receive the above configuration information, first, and second indications.

According to some embodiments of the present application, before transmitting the SCI, the target UE may receive configuration information from the network. The configuration information may include a first SL-PRS configuration and a second SL-PRS configuration.

The first SL-PRS configuration is associated with transmission of the SL-PRS on a PSSCH. The SL-PRS which is transmitted on a PSSCH may also be referred to as a PRS-based SL-PRS. The first SL-PRS configuration may include at least one of:
(1) a start symbol of the SL-PRS in the time domain (e.g., 1_offset symbol). For example, for a resource pool with a slot patterns (a) and (b) in FIG. 3, 1_offset symbol may be 4 (e.g., the start symbol of the SL-PRS is symbol #4); for a resource pool with a slot patterns (a′) and (b′) as shown in FIG. 4, 1_offset symbol may be 3 (e.g., the start symbol of the SL-PRS is symbol #3);
(2) an offset value of the SL-PRS in the frequency domain (e.g., K0). K0 is an offset value in the frequency domain per a UE with respect to “subcarrier 0” of a physical resource block (PRB). K0 may be configured as a “per UE offset value”. That is, for different UEs, the values of K0 are different.
(3) A total number of SL-PRS symbols (e.g., L_{PRS}). For example, the total number of SL-PRS symbols may be defined as any of {6, 7, 9, 10} according to a slot pattern as shown in FIGS. 3-4. Specifically, for a resource pool with a slot pattern (a) as shown in FIG. 3, the total number of SL-PRS symbols in PSSCH may be 9 (i.e., symbols #4 to #12); for a resource pool with a slot pattern (b) as shown in FIG. 3, the total number of SL-PRS symbols in PSSCH may be 6 (i.e., symbols #4 to #9); for a resource pool with a slot pattern (a′) as shown in FIG. 4, the total number of SL-PRS symbols in PSSCH may be 10 (i.e., symbols #3 to #12); for a resource pool with a slot pattern (b′) as shown in FIG. 4, the total number of SL-PRS symbols in PSSCH may be 7 (i.e., symbols #3 to #9);
(4) A comb value. For example, the comb value may be any one of {2, 4, 8} as defined in 3GPP standard document TS 38.211;
(5) A SL-PRS RE offset value set. The SL-PRS RE offset set is associated with the total number of SL-PRS symbols and the comb value. A total number of offset value(s) within the SL-PRS RE offset set equals to the total number of SL-PRS symbols;

The following table 1 illustrates the SL-PRS RE offset value set, which is associated with the total number of SL-PRS symbols L_{PRS} and the comb value.

TABLE 1
SL-PRS RE offset value set

| comb | L_{PRS} | | | |
|---|---|---|---|---|
| value | 6 | 7 | 9 | 10 |
| 2 | {0, 1, 0, 1, 0, | {0, 1, 0, 1, | {0, 1, 0, 1, 0, | {0, 1, 0, 1, 0, 1, |
| | 1} | 0, 1, 0} | 1, 0, 1, 0} | 0, 1, 0, 1} |
| 4 | {0, 2, 1, 3, 0, | {0, 2, 1, 3, | {0, 2, 1, 3, 0, | {0, 2, 1, 3, 0, 2, |
| | 2} | 0, 2, 1} | 2, 1, 3, 0} | 1, 3, 0, 2} |
| 8 | {0, 4, 2, 6, 1, | {0, 4, 2, 6, | {0, 4, 2, 6, 1, | {0, 4, 2, 6, 1, 5, |
| | 5} | 1, 5, 3} | 5, 3, 7, 0} | 3, 7, 0, 4} |

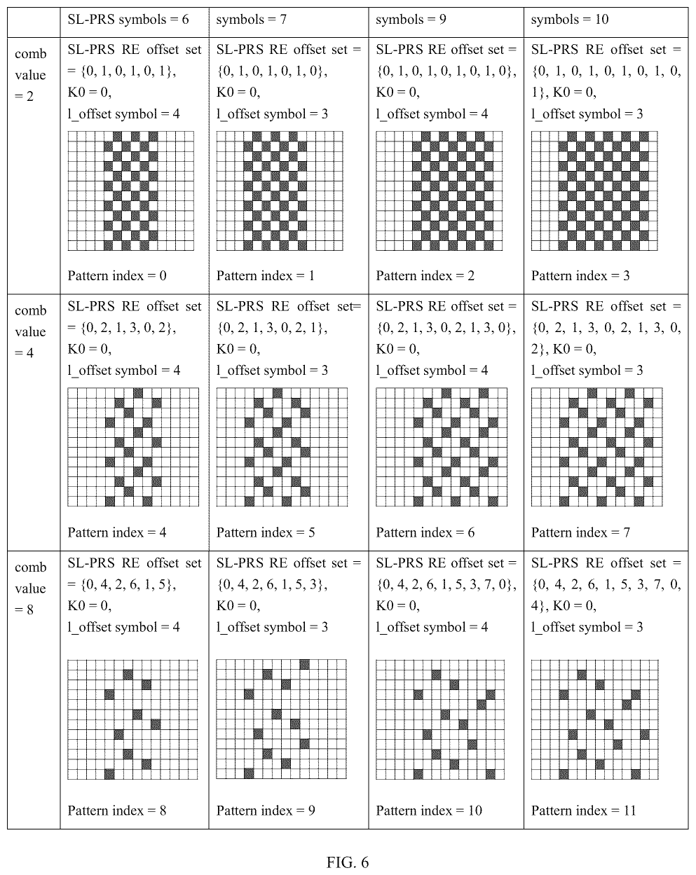

Referring to table 1, based on the total number of SL-PRS symbols {6, 7, 9, 10} and the comb value {2, 4, 8}, the twelve SL-PRS RE offset value sets may be determined. The twelve SL-PRS RE offset value sets in table 1 may correspond to twelve PRS patterns, which are illustrated in FIG. 6.

Specifically, FIG. 6 illustrates twelve exemplary SL-PRS patterns in PSSCH according to some embodiments of the present application.

Referring to FIG. 6, each of these twelve SL-PRS patterns has an index value, i.e., Pattern index=0, 1, 2, 3, 4, 5, 6, 7, 8, 9, 10, and 11 as shown in FIG. 6. For simplicity, each PRS pattern in FIG. 6 is illustrated in units of one RB (e.g., including 12 REs (i.e., RE #0 to RE #11)) in the frequency domain and one timeslot (e.g., including 14 symbols (i.e., symbol #0 to symbol #13)) in the time domain. Persons skilled in the art can determine that the distribution principle shown in one RB in FIG. 6 can be used for other RBs of the PSSCH. Referring to FIG. 6, each PRS pattern includes several REs for SL-PRS transmission, which are shown as black pieces in FIG. 6.

Each of these PRS patterns may be determined by a corresponding first SL-PRS configuration.

Taking the first PRS pattern, i.e., Pattern index=0 as an example, it corresponds to a first SL-PRS configuration including: 1_offset symbol=4; K0=0; total number of SL-PRS symbols=6; comb value=2; SL-PRS RE offset set={0, 1, 0, 1, 0, 1}.

Specifically, the comb value may be used to determine interval (e.g., in units of RE) in the frequency domain between two adjacent REs for SL-PRS transmission, e.g., the interval in the frequency domain between two adjacent REs for SL-PRS transmission is “comb value-1”. For example, “comb value=2” may mean that the interval in the frequency domain between the two adjacent REs for SL-PRS transmission is 1.

The SL-PRS RE offset set may indicate a RE offset for SL-PRS transmission in each symbol. For example, for the SL-PRS RE offset set={0, 1, 0, 1, 0, 1}, the first bit “0” may mean that the RE offset in the first symbol (e.g., symbol #4) is 0, the second bit “1” may mean that the RE offset in the second symbol (e.g., symbol #5) is 1, the third bit “0” may mean that the RE offset in the third symbol (e.g., symbol #6) is 0, the fourth bit “1” may mean that the RE offset in the fourth symbol (e.g., symbol #7) is 1, the fifth bit “0” may mean that the RE offset in the fifth symbol (e.g., symbol #8) is 0, the sixth bit “1” may mean that the RE offset in the sixth symbol (e.g., symbol #9) is 1.

The SL-PRS RE offset set and K0 may be used to determine the start RE for SL-PRS transmission in each symbol. For example, for the SL-PRS RE offset set={0, 1, 0, 1, 0, 1} and K0=0, the start REs for SL-PRS transmission in symbols #4 to #9 are RE #0, RE #1. RE #0, RE #1, RE #0, RE #1.

The embodiments shown in FIG. 6 illustrate the PRS pattern for one anchor UE. However, in some embodiments of the present application, the PSSCH may be used for SL-PRS transmissions for multiple UEs. In such embodiments, the starting point of PSCCH in the frequency domain for a UE of the multiple UEs is determined based on at least one of: comb value, SL-PRS RE offset set, or K0 associated with the UE.

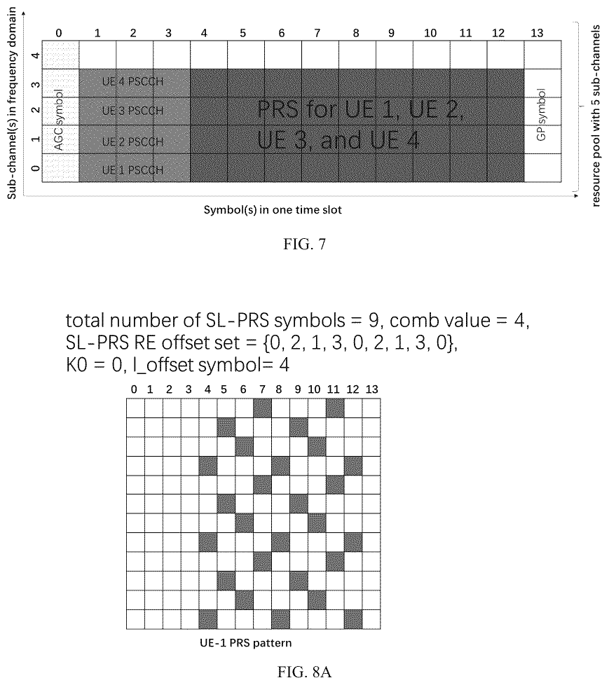

For example, FIG. 7 illustrates exemplary SL-PRS transmissions for four UEs according to some embodiments of the present application. The slot pattern in FIG. 7 may be similar to slot pattern (a) in FIG. 3. Specifically. FIG. 7 also shows 14 symbols in one time slot in time domain (which are marked as #0 to #13, respectively) and a resource pool with 5 sub-channels in frequency domain (which are marked as #0 to #4, respectively).

Referring to FIG. 7, symbol #0 in the time slot and sub-channels #0, #1, #2, #3, and #4 in the frequency domain carry an AGC symbol. The starting point of PSCCH in the frequency domain for a UE of the fourth UEs is determined based on at least one of: comb value. SL-PRS RE offset set, or K0 associated with the UE. For example, in FIG. 7, symbols #1-#3 in the time slot and sub-channels #0, #1, #2, and #3 in the frequency domain carry UE 1 PSCCH transmission, UE 2 PSCCH transmission, UE 3 PSCCH transmission, and UE 4 PSCCH transmission, respectively. In other words, UE 1 PSCCH transmission, UE 2 PSCCH transmission, UE 3 PSCCH transmission, or UE 4 PSCCH transmission is carried by 1 sub-channel in the frequency domain and 3 symbols in the time domain.

Symbol #13 in the time slot and sub-channels #0, #1, #2, #3, and #4 in frequency domain carry a GP symbol.

In the embodiments of FIG. 7, symbol #4 to symbol #12 in the time slot and sub-channels #0, #1, #2, #3 in the frequency domain carry PRS transmissions for UE 1, UE 2, UE 3, and UE 4.

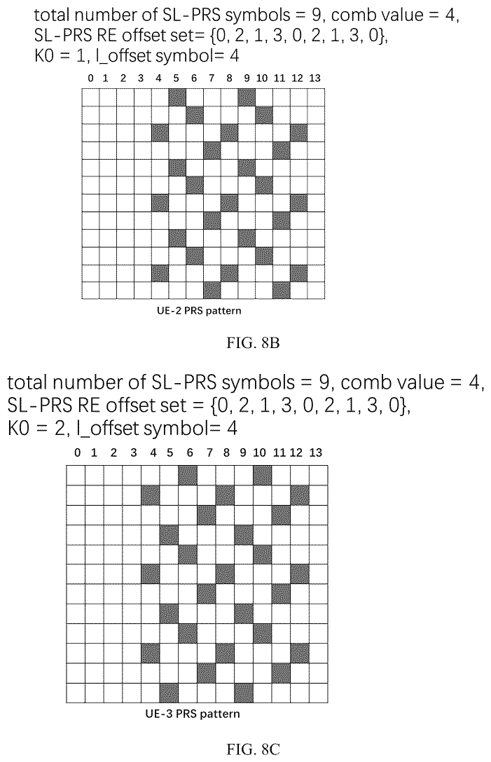

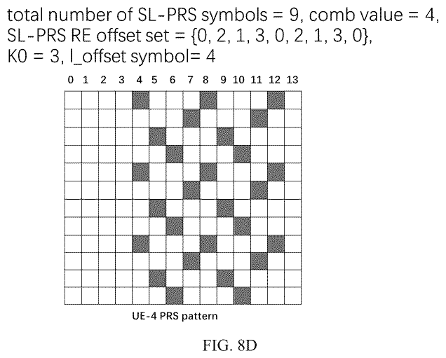

The specific PRS pattern for each of UE 1, UE 2, UE 3, and UE 4 may be illustrated in FIGS. 8A-8D, respectively.

Specifically, FIGS. 8A-8D illustrate four exemplary SL-PRS patterns in PSSCH according to some embodiments of the present application. The embodiments of FIGS. 8A-8D show exemplary SL-PRS patterns of four UEs, i.e., UE-1 PRS pattern, UE-2 PRS pattern. UE-3 PRS pattern, and UE-4 PRS pattern.

UE-1 PRS pattern as shown in FIG. 8A is the same as the seventh PRS pattern in the embodiments of FIG. 6, i.e., Pattern index=6. UE-1 PRS pattern corresponds to a first SL-PRS configuration including: a total number of SL-PRS symbols=9, a comb value=4, a SL-PRS RE offset set={0, 2, 1, 3, 0, 2, 1, 3, 0}, K0=0, and 1_offset symbol=4.

UE-2 PRS pattern, UE-3 PRS pattern, and UE-4 PRS pattern respectively shown in FIGS. 8B-8D are similar to UE-1 PRS pattern in FIG. 8A. The PRS patterns in FIGS. 8B-8D correspond to the same total number of SL-PRS symbols, the same comb value, the same SL-PRS RE offset set, and the same 1_offset symbol as those of UE-1 PRS pattern in FIG. 8A. However, the PRS patterns in FIGS. 8B-8D correspond to different K0 values from K0=0 of UE-1 PRS pattern in FIG. 8A. In particular:
1) UE-1 PRS pattern in FIG. 8A corresponds to K0=0, the start REs for SL-PRS transmission in symbols #4 to #12 are determined by K0=0 and SL-PRS RE offset set={0, 2, 1, 3, 0, 2, 1, 3, 0}.
2) UE-2 PRS pattern in FIG. 8B corresponds to K0=1, the start REs for SL-PRS transmission in symbols #4 to #12 are determined by K0=1 and SL-PRS RE offset set={0, 2, 1, 3, 0, 2, 1, 3, 0}.
3) UE-3 PRS pattern in FIG. 8C corresponds to K0=2, the start REs for SL-PRS transmission in symbols #4 to #12 are determined by K0=2 and SL-PRS RE offset set={0, 2, 1, 3, 0, 2, 1·3, 0}.
4) UE-4 PRS pattern in FIG. 8D corresponds to K0=3, the start REs for SL-PRS transmission in symbols #4 to #12 are determined by K0=3 and SL-PRS RE offset set={0, 2, 1, 3, 0, 2, 1, 3, 0}.

Although FIGS. 7 and 8A-8D illustrate that PSSCH are used for transmitting SL-PRS for four UEs, persons skilled in the art can understand that the PSSCH can also used for transmitting SL-PRS for any other number of UEs in some other embodiments. In addition, Although the SL-PRS patterns in FIGS. 8A-8D are illustrated based on the total number of SL-PRS symbols=9, comb value=4, SL-PRS RE offset set={0, 2, 1, 3, 0, 2, 1, 3, 0}, and 1_offset symbol=4, person skilled in the art can understand other values of the above parameter as illustrated in FIGS. 3-6 can also be used for determine SL-PRS patterns for multiple UEs.

The second SL-PRS configuration is associated with transmission of the SL-PRS on a PSFCH. The SL-PRS which is transmitted on a PSFCH may also be referred to as a sounding reference signal (SRS)-based SL-PRS. The second SL-PRS configuration may include at least one of:
(1) A start symbol of the SL-PRS in the time domain (e.g., 1_offset). For example, for a resource pool with a slot pattern (b) as shown in FIGS. 3 and 4, 1_offset may be 11 (e.g., the start symbol of the SL-PRS is symbol #11);
(2) An offset value of the SL-PRS in the frequency domain (e.g., K0). K0 is an offset value in the frequency domain per a UE with respect to “subcarrier 0” of a physical resource block (PRB). K0 may be configured as a “per UE offset value”. That is, for different UEs, the values of K0 are different.
(3) A total number of SL-PRS symbols (e.g., NPRs). For example, the total number of SL-PRS symbols in PSFCH may be 2 (i.e., symbols #11 to #12) as shown in FIGS. 3-4.
(4) A comb value. For example, the comb value may be any one of {2, 4} as defined in 3GPP standard document TS 38.211;
(5) A SL-PRS RE offset value set. The SL-PRS RE offset set is associated with the total number of SL-PRS symbols and the comb value. A total number of offset value(s) within the SL-PRS RE offset set equals to the total number of SL-PRS symbols in the PSFCH;

The following table 2 illustrates the SL-PRS RE offset value set, which is associated with the total number of SL-PRS symbols NPRs and the comb value.

TABLE 2
SL-PRS RE offset value set

| | L_{PRS} |
|---|---|
| comb value | 2 |
| 2 | {0, 1} |
| 4 | {0, 2} |

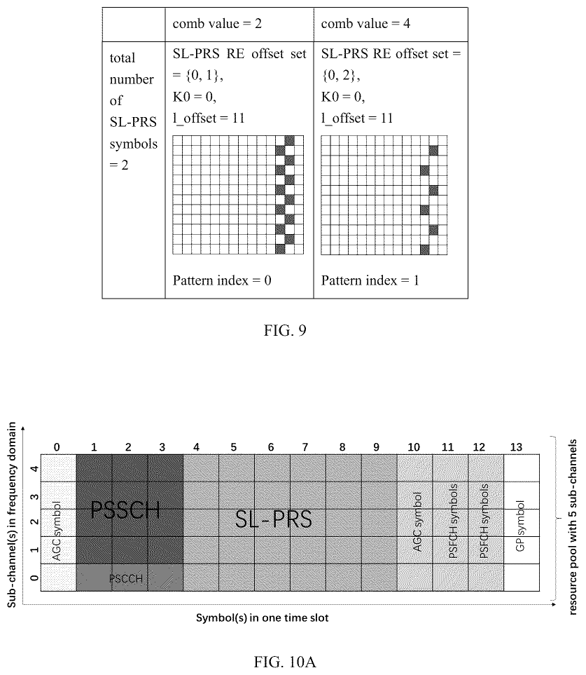

Referring to table 2, based on the total number of SL-PRS symbols {2} and the comb value {2, 4}, the two SL-PRS RE offset value sets may be determined. The two SL-PRS RE offset value sets in table 2 may correspond to two PRS patterns in PSFCH, which are illustrated in FIG. 9.

Specifically, FIG. 9 illustrates two exemplary SL-PRS patterns in PSFCH according to some embodiments of the present application.

Referring to FIG. 9, each of these two SL-PRS patterns has an index value, i.e., Pattern index=0 and 1 as shown in FIG. 9. For simplicity, each PRS pattern in FIG. 9 is illustrated in units of one RB (e.g., including 12 REs (i.e., RE #0 to RE #11)) in the frequency domain and one timeslot (e.g., including 14 symbols (i.e., symbol #0) to symbol #13)) in the time domain. Persons skilled in the art can determine that the distribution principle shown in one RB in FIG. 9 can be used for other RBs of the PSSCH. Referring to FIG. 9, each PRS pattern includes several REs for SL-PRS transmission, which are shown as black pieces in FIG. 9.

Each of these PRS patterns may be determined by a corresponding second SL-PRS configuration.

Taking the first PRS pattern, i.e., Pattern index=0 as an example, it corresponds to a second SL-PRS configuration including: 1_offset=11: K0=0; total number of SL-PRS symbols=2: comb value=2: SL-PRS RE offset set={0, 1}.

Specifically, the comb value may be used to determine interval (e.g., in units of RE) in the frequency domain between two adjacent REs for SL-PRS transmission, e.g., the interval in the frequency domain between two adjacent REs for SL-PRS transmission is “comb value-1”. For example, “comb value=2” may mean that the interval in the frequency domain between the two adjacent REs for SL-PRS transmission is 1.

The SL-PRS RE offset set may indicate a RE offset for SL-PRS transmission in each symbol. For example, for the SL-PRS RE offset set={0, 1}, the first bit “0” may mean that the RE offset in the first symbol (e.g., symbol #11) is 0, the second bit “1” may mean that the RE offset in the second symbol (e.g., symbol #12) is 1.

The SL-PRS RE offset set and K0 may be used to determine the start RE for SL-PRS transmission in each symbol. For example, for the SL-PRS RE offset set={0, 1}, the start REs for SL-PRS transmission in symbols #11 and #12 are RE #0 and RE #1, which are determined by K0=0 and SL-PRS RE offset set={0, 1}.

After receiving the first SL-PRS configuration and the second SL-PRS configuration, the target UE may transmit the SCI to the anchor UE, the SCI may include a 1-bit indication indicating that either the first SL-PRS configuration or the second SL-PRS configuration is used for transmitting the SL-PRS. For example, the 1-bit indication with value “1” represents that the first SL-PRS configuration is used for transmitting the SL-PRS, whereas the 1-bit indication with value “0” represents that the second SL-PRS configuration is used for transmitting the SL-PRS, and vice versa.

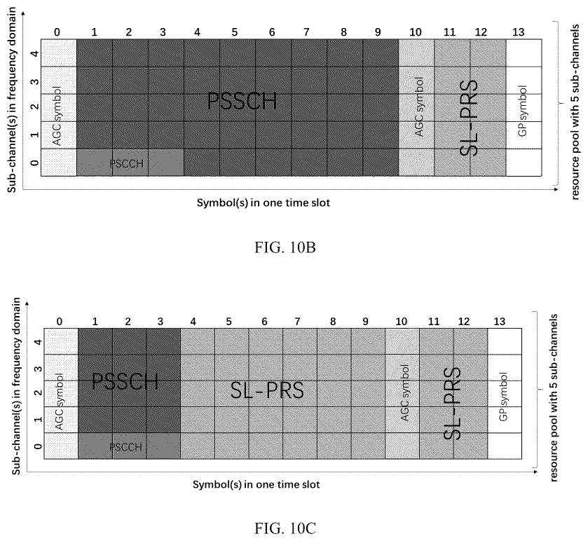

According to some other embodiments of the present application, the target UE may not receive the first SL-PRS configuration and the second SL-PRS configuration. In such embodiments, the SCI may include a 1-bit indication indicating that the SL-PRS is transmitted on either a PSSCH or a PSFCH. For example, the 1-bit indication with value “1” represents that the SL-PRS is transmitted on the PSSCH, which is shown in FIG. 10A as an example, whereas the 1-bit indication with value “O” represents that the SL-PRS is transmitted on the PSFCH, which is shown in FIG. 10B as an example.

According to some other embodiments of the present application, the target UE may receive configuration information from the network. The configuration information may indicate two of the following three configurations: the SL-PRS can be transmitted on a PSSCH, the SL-PRS can be transmitted on a PSFCH, and the SL-PRS can be transmitted on both the PSSCH and the PSFCH. In such embodiments, after receiving the configuration information, the target UE may transmit the SCI to the anchor UE, the SCI includes a 1-bit indication indicating one of the two configurations is used for transmitting the SL-PRS. For example, the configuration information may indicate: the SL-PRS can be transmitted on a PSSCH and the SL-PRS can be transmitted on both the PSSCH and the PSFCH, and the 1-bit indication may indicate that the SL-PRS is transmitted on both the PSSCH and the PSFCH, which is shown in FIG. 10C as an example.

According to some other embodiments of the present application, the target UE may not receive the configuration information indicating the two configurations from the three configurations from the network. In such embodiments, the SCI includes a 2-bit indication indicating that: the SL-PRS is transmitted on a PSSCH: the SL-PRS is transmitted on a PSFCH: or the SL-PRS is transmitted on both the PSSCH and the PSFCH. For example, the 2-bit indication with value “00” represents that the SL-PRS is transmitted on the PSSCH, the 2-bit indication with value “01” represents that the SL-PRS is transmitted on the PSFCH, the 2-bit indication with value “10” represents that the SL-PRS is transmitted on both the PSSCH and the PSFCH, the 2-bit indication with value “00” represents that the SL-PRS is not transmitted on the PSSCH and the PSFCH.

FIGS. 10A-10C illustrate exemplary SL-PRS transmission according to some embodiments of the present application. The slot pattern used in FIGS. 10A-10C is slot pattern (b) in FIG. 3.

Referring to FIG. 10A, the SL-PRS is transmitted on the PSSCH. Referring to FIG. 10B, the SL-PRS is transmitted on the PSFCH. Referring to FIG. 10C, the SL-PRS is transmitted on both the PSSCH and the PSFCH.

In some embodiments of the present application, transmitting the SL-PRS on the PSSCH refer to transmitting the SL-PRS in the symbols of PSSCH which are not used for transmitting the PSCCH. For example, referring to FIGS. 10A and 10C, symbols #1-#3 used for transmitting both the PSSCH and PSCCH, and thus the SL-PRS are not transmitted in symbols #1-#3 because the PSSCH in symbols #1-#3 may be used for transmitting a portion of information in the SCI (e.g., the second stage SCI). In other words, transmitting the SL-PRS on the PSSCH refer to transmitting the SL-PRS in symbols #4-#9 of PSSCH which are not used for transmitting the PSCCH.

Although embodiments of FIGS. 10A-10C take the slot pattern (b) in FIG. 3 as an example for illustration, persons skilled in the art can understand that slot pattern (b′) in FIG. 4 may also be used for SL-PRS transmission in some other embodiments of the present application.

According to some embodiments of the present application, before transmitting the SCI, the target UE may receive configuration information per resource pool indicating that the SL-PRS can be transmitted on either a PSSCH or a PSFCH. In such embodiments, in the case that the configuration information indicates that the SL-PRS can be transmitted on the PSSCH, the SCI includes a 1-bit indication indicating whether data or the SL-PRS is transmitted on the PSSCH. For example, the 1-bit indication with value “1” indicates that the SL-PRS is transmitted on the PSSCH, and the 1-bit indication with value “O” indicates that the data is transmitted on the PSSCH. In the case that the configuration information indicates that the SL-PRS can be transmitted on the PSFCH, the SCI includes a 1-bit indication indicating whether feedback information or the SL-PRS is transmitted on the PSFCH. For example, the 1-bit indication with value “1” indicates that the SL-PRS is transmitted on the PSFCH, and the 1-bit indication with value “0” indicates that the feedback information (e.g., HARQ acknowledgment (HARQ-ACK) or HARQ non-acknowledgment (NACK) is transmitted on the PSFCH.

According to some other embodiments of the present application, before transmitting the SCI, the target UE may receive configuration information per resource pool indicating that the SL-PRS can be transmitted on at least one of a PSSCH or a PSFCH. In such embodiments, the SCI may include 2-bit indication indicating that the SL-PRS is transmitted on the PSSCH, the PSFCH or both. For example, 2-bit indication with value “00” represents data is transmitted on the PSSCH and feedback information is transmitted on the PSFCH, i.e., SL-PRS is not transmitted on associated PSSCH and SL-PRS is not transmitted on associated PSFCH: 2-bit indication with value “01” represents SL-PRS is transmitted on the PSSCH and SL-PRS is not transmitted on the PSFCH: 2-bit indication with value “10” represents that SL-PRS is not transmitted on the PSSCH and SL-PRS is transmitted on the PSFCH; and 2-bit indication with value “11” represents that SL-PRS is transmitted on the PSSCH and SL-PRS is transmitted on the PSFCH.

After transmitting the SCI to the anchor UE, in step 502, the target UE may transmit the SL-PRS based on the SCI to the anchor UE.

FIG. 11 is a flow chart illustrating an exemplary method for SL-PRS transmission according to some other embodiments of the present application. The method illustrated in FIG. 11 may be performed by a target UE. In the embodiments of FIG. 11, the sidelink transmission (including the SL-PRS transmission) may be worked in mode 1 as specified in 3GPP standard documents, i.e., the resource for sidelink transmission is determined by the network.

The difference between FIG. 5 and FIG. 11 is that in FIG. 11, before transmitting the SCI, the target UE may receive DCI from the network (e.g., from a BS) in step 1101. The DCI may be used for scheduling a sidelink transmission, which includes the SCI and SL-PRS transmission associated with the SCI. The DCI may indicate the at least one sidelink resource for transmitting the SL-PRS. After receiving the DCI from the network, the target UE may generate the SCI based on the DCI. Then, in step 1102, the target UE may transmit the SCI to an anchor UE.

According to some embodiments of the present application, before receiving the DCI, the target UE may receive at least one of:
the configuration information as stated above, which indicates whether a resource pool used for data transmission can be used for transmitting the SL-PRS:
the first indication as stated above, which indicates whether at least one slot of the resource pool can be used for transmitting the SL-PRS; or
the second indication as stated above, which indicates whether a RB of the resource pool can be used for transmitting the SL-PRS.

According to some embodiments of the present application, before receiving the DCI, the target UE may receive configuration information from the network. The configuration information may include a first SL-PRS configuration and a second SL-PRS configuration. The first SL-PRS configuration is associated with transmission of the SL-PRS on a PSSCH. The second SL-PRS configuration is associated with transmission of the SL-PRS on a PSFCH. The contents included in the first SL-PRS configuration and the second SL-PRS configuration may be the same as those in FIG. 5.

After receiving the first SL-PRS configuration and the second SL-PRS configuration, the target UE may receive the DCI from the network, then, the target UE may generate and transmit the SCI to the anchor UE. Each of the DCI and the SCI may include a 1-bit indication indicating that either the first SL-PRS configuration or the second SL-PRS configuration is used for transmitting the SL-PRS. That is, the DCI and the SCI may include the same 1-bit indication. For example, the 1-bit indication in the DCI may indicate the first SL-PRS configuration, and thus the 1-bit indication in the SCI may also indicate the first SL-PRS configuration.

According to some other embodiments of the present application, the target UE may not receive the first SL-PRS configuration and the second SL-PRS configuration. In such embodiments, the target UE may receive the DCI, and then generate and transmit the SCI to the anchor UE. Each of the DCI and the SCI may include a 1-bit indication indicating that the SL-PRS is transmitted on either a PSSCH or a PSFCH. That is, the DCI and the SCI may include the same 1-bit indication. For example, the 1-bit indication in the DCI may indicate the SL-PRS is transmitted on a PSSCH, and thus the 1-bit indication in the SCI may also indicate the SL-PRS is transmitted on a PSSCH.

According to some other embodiments of the present application, before receiving the DCI, the target UE may receive configuration information from the network. The configuration information may indicate two of the following three configurations: the SL-PRS can be transmitted on a PSSCH, the SL-PRS can be transmitted on a PSFCH, and the SL-PRS can be transmitted on both the PSSCH and the PSFCH. In such embodiments, after receiving the configuration information, the target UE may receive DCI from the network, then the target UE may generate and transmit the SCI to the anchor. Each of the DCI and the SCI may include a 1-bit indication indicating one of the two configurations is used for transmitting the SL-PRS. That is, the DCI and the SCI may include the same 1-bit indication.

According to some other embodiments of the present application, the target UE may not receive the configuration information indicating the two configurations from the network. In such embodiments, the UE may receive the DCI from the network, then the UE may generate and transmit the SCI to the anchor UE. Each of the DCI and the SCI may include a 2-bit indication indicating that: the SL-PRS is transmitted on a PSSCH; the SL-PRS is transmitted on a PSFCH: or the SL-PRS is transmitted on both the PSSCH and the PSFCH. That is, the DCI and the SCI may include the same 2-bit indication.

According to some embodiments of the present application, before receiving the DCI, the target UE may receive configuration information per resource pool indicating that the SL-PRS can be transmitted on either a PSSCH or a PSFCH. In such embodiments, after receiving the DCI, the target UE may generate and transmit the DCI to the anchor UE. In the case that the configuration information indicates that the SL-PRS can be transmitted on the PSSCH, each of the DCI and the SCI includes a 1-bit indication indicating whether data or the SL-PRS is transmitted on the PSSCH. For example, the 1-bit indication with value “1” in the DCI and the SCI indicates that the SL-PRS is transmitted on the PSSCH, and the 1-bit indication with value “0” indicates that the data is transmitted on the PSSCH. In the case that the configuration information indicates that the SL-PRS can be transmitted on the PSFCH, the DCI and the SCI includes a 1-bit indication indicating whether feedback information or the SL-PRS is transmitted on the PSFCH. For example, the 1-bit indication with value “I” in the DCI and the SCI indicates that the SL-PRS is transmitted on the PSFCH, and the 1-bit indication with value “0” indicates that the feedback information (e.g., HARQ-ACK or HARQ NACK) is transmitted on the PSFCH.

According to some other embodiments of the present application, before receiving the DCI, the target UE may receive configuration information per resource pool indicating that the SL-PRS can be transmitted on at least one of a PSSCH or a PSFCH. In such embodiments, after receiving the DCI, the target UE may generate and transmit the SCI to the anchor UE. Each of the SCI and the DCI may include 2-bit indication indicating that the SL-PRS is transmitted on the PSSCH, the PSFCH or both. For example, 2-bit indication with value “00” in the DCI and the SCI represents data is transmitted on the PSSCH and feedback information is transmitted on the PSFCH, i.e., SL-PRS is not transmitted on associated PSSCH and SL-PRS is not transmitted on associated PSFCH: 2-bit indication with value “01” in the DCI and the SCI represents SL-PRS is transmitted on the PSSCH and SL-PRS is not transmitted on the PSFCH: 2-bit indication with value “10” in the DCI and the SCI represents that SL-PRS is not transmitted on the PSSCH and SL-PRS is transmitted on the PSFCH; and 2-bit indication with value “11” in the DCI and the SCI represents that SL-PRS is transmitted on the PSSCH and SL-PRS is transmitted on the PSFCH.

After transmitting the SCI in step 1102, in step 1103, the target UE may transmit the SL-PRS based on the SCI to the anchor UE.

In the embodiments of FIG. 5 and FIG. 11, for a sidelink slot where PSFCH is not configured, the target UE may not transmit the SL-PRS in the PSFCH even if the SCI indicates that the SL-PRS is to be transmitted on the PSFCH.

In some embodiments of the present application, the SCI in FIGS. 5 and 11 may include a first stage SCI and a second stage SCI. The first stage SCI is transmitted in PSCCH as shown in FIG. 3 and FIG. 4. The second stage SCI may be transmitted in PSSCH, the symbols of the PSSCH for transmitting the second stage SCI may be the same as the symbols for transmitting the PSCCH, for example, as shown in FIG. 3, the PSCCH is transmitted on symbols #1-#3 in the time domain and in the sub-channel #0 in the frequency domain, and the symbols #1-#3 in the time domain and the sub-channel #1-#4 in the frequency domain may be sued for transmitting the PSSCH. In such cases, the first stage SCI is transmitted in the PSCCH, and the second stage SCI is transmitted on the symbols #1-#3 in the time domain and the sub-channel #1-#4 in the frequency domain. The 1-bit indication and the 2-bit indication in the SCI as illustrated in FIG. 5 and FIG. 11 may be included in at least one of the first stage SCI and the second stage SCI.

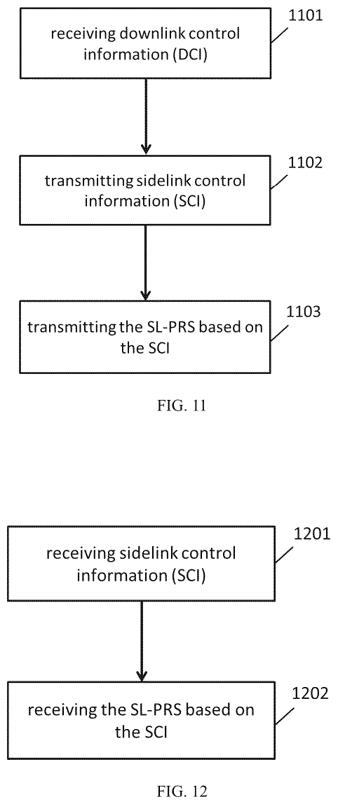

FIG. 12 is a flow chart illustrating an exemplary method for SL-PRS transmission according to some other embodiments of the present application. The method illustrated in FIG. 12 may be performed by an anchor UE. Persons skilled in the art can understand that the method described with respect to the UE can be implemented by other apparatus with the like functions.

In step 1201, the anchor UE may receive SCI from a target UE. The target UE may be a UE at which a location service request is initiated or occurs. In other words, the target UE may be a UE that wants to know its own position. The anchor UE may be a UE that participates in SL positioning and helps the target UE to acquire its position. e.g., by sending/receiving SL-PRS and doing relevant measurements. For example, the target UE may be UE 102a as shown in FIG. 1 and the anchor UE may be UE 102b or UE 102c as shown in FIG. 1. In another example, the target UE may be UE 102d as shown in FIG. 1 and the anchor UE may be UE 102b or UE 102c as shown in FIG. 1.

The SCI may indicate at least one sidelink resource for transmitting an SL-PRS.

According to some embodiments of the present application, before receiving the SCI, the anchor UE may receive at least one of:
the configuration information as stated above, which indicates whether a resource pool used for data transmission can be used for transmitting the SL-PRS:
the first indication as stated above, which indicates whether at least one slot of the resource pool can be used for transmitting the SL-PRS; or
the second indication as stated above, which indicates whether a RB of the resource pool can be used for transmitting the SL-PRS.

According to some other embodiments, before receiving the SCI, the anchor UE does not receive the above configuration information, first, and second indications.

According to some embodiments of the present application, before receiving the SCI, the target UE may receive configuration information from the network. The configuration information may include a first SL-PRS configuration and a second SL-PRS configuration as illustrated in FIG. 5.

After receiving the first SL-PRS configuration and the second SL-PRS configuration, the anchor UE may receive the SCI from the target UE, the SCI may include a 1-bit indication indicating that either the first SL-PRS configuration or the second SL-PRS configuration is used for transmitting the SL-PRS. For example, the 1-bit indication with value “1” represents that the first SL-PRS configuration is used for transmitting the SL-PRS, whereas the 1-bit indication with value “0” represents that the second SL-PRS configuration is used for transmitting the SL-PRS, and vice versa.

According to some other embodiments of the present application, the anchor UE may not receive the first SL-PRS configuration and the second SL-PRS configuration. In such embodiments, the SCI may include a 1-bit indication indicating that the SL-PRS is transmitted on either a PSSCH or a PSFCH.

According to some other embodiments of the present application, the anchor UE may receive configuration information from the network. The configuration information may indicate two of the following three configurations: the SL-PRS can be transmitted on a PSSCH, the SL-PRS can be transmitted on a PSFCH, and the SL-PRS can be transmitted on both the PSSCH and the PSFCH. In such embodiments, after receiving the configuration information, the anchor UE may receive the SCI from the target UE, the SCI includes a 1-bit indication indicating one of the two configurations is used for transmitting the SL-PRS.

According to some other embodiments of the present application, the anchor UE may not receive the configuration information indicating the two configurations from the three configurations from the network. In such embodiments, the SCI includes a 2-bit indication indicating that: the SL-PRS is transmitted on a PSSCH: the SL-PRS is transmitted on a PSFCH, or the SL-PRS is transmitted on both the PSSCH and the PSFCH.

According to some embodiments of the present application, before receiving the SCI, the anchor UE may receive configuration information per resource pool indicating that the SL-PRS can be transmitted on either a PSSCH or a PSFCH. In such embodiments, in the case that the configuration information indicates that the SL-PRS can be transmitted on the PSSCH, the SCI includes a 1-bit indication indicating whether data or the SL-PRS is transmitted on the PSSCH. In the case that the configuration information indicates that the SL-PRS can be transmitted on the PSFCH, the SCI includes a 1-bit indication indicating whether feedback information or the SL-PRS is transmitted on the PSFCH.

According to some other embodiments of the present application, before receiving the SCI, the target UE may receive configuration information per resource pool indicating that the SL-PRS can be transmitted on at least one of a PSSCH or a PSFCH. In such embodiments, the SCI may include 2-bit indication indicating that the SL-PRS is transmitted on the PSSCH, the PSFCH or both.

After receiving the SCI from the target UE, in step 1202, the anchor UE may receive the SL-PRS based on the SCI from the target UE.

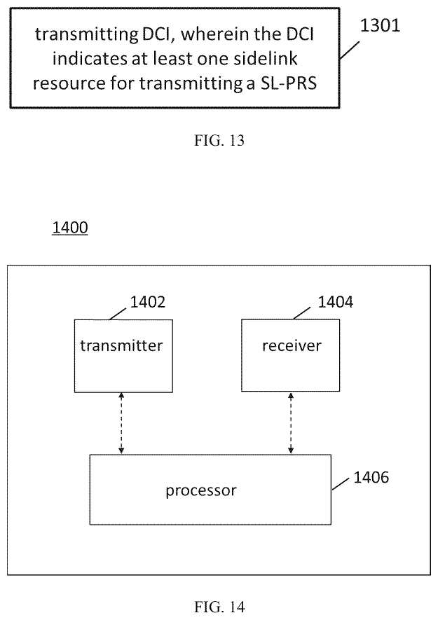

FIG. 13 is a flow chart illustrating an exemplary method for SL-PRS transmission according to some other embodiments of the present application. The method illustrated in FIG. 13 may be performed by a network entity (e.g., a BS or a location management function (LMF)).

Referring to FIG. 13, in step 1301, the network entity may transmit DCI to a target UE. The target UE may be a UE at which a location service request is initiated or occurs. In other words, the target UE may be a UE that wants to know its own position. The DCI may be used for scheduling a sidelink transmission, which includes the SCI and SL-PRS transmission associated with the SCI. The DCI may indicate the at least one sidelink resource for transmitting the SL-PRS by the target UE.

According to some embodiments of the present application, before receiving the DCI, the network entity may transmit at least one of:
the configuration information as stated above, which indicates whether a resource pool used for data transmission can be used for transmitting the SL-PRS:
the first indication as stated above, which indicates whether at least one slot of the resource pool can be used for transmitting the SL-PRS; or
the second indication as stated above, which indicates whether a RB of the resource pool can be used for transmitting the SL-PRS.

According to some embodiments of the present application, before transmitting the DCI, the network entity UE may transmit configuration information to the target UE. The configuration information may include a first SL-PRS configuration and a second SL-PRS configuration. The first SL-PRS configuration is associated with transmission of the SL-PRS on a PSSCH. The second SL-PRS configuration is associated with transmission of the SL-PRS on a PSFCH. The contents included in the first SL-PRS configuration and the second SL-PRS configuration may be the same as those in FIG. 5.

After transmitting the first SL-PRS configuration and the second SL-PRS configuration, the network entity may transmit the DCI to the target UE. The DCI may include a 1-bit indication indicating that either the first SL-PRS configuration or the second SL-PRS configuration is used for transmitting the SL-PRS.

According to some other embodiments of the present application, the network entity may not receive the first SL-PRS configuration and the second SL-PRS configuration. In such embodiments, the DCI may include a 1-bit indication indicating that the SL-PRS is transmitted on either a PSSCH or a PSFCH.

According to some other embodiments of the present application, before transmitting the DCI, the network entity may transmit configuration information to the target UE. The configuration information may indicate two of the following three configurations: the SL-PRS can be transmitted on a PSSCH, the SL-PRS can be transmitted on a PSFCH, and the SL-PRS can be transmitted on both the PSSCH and the PSFCH. In such embodiments, after transmitting the configuration information, the network entity may transmit DCI to the target UE, the DCI may include a 1-bit indication indicating one of the two configurations is used for transmitting the SL-PRS.

According to some other embodiments of the present application, the network entity may not transmit the configuration information indicating the two configurations to the target UE. In such embodiments, the DCI transmitted by the network entity may include a 2-bit indication indicating that: the SL-PRS is transmitted on a PSSCH; the SL-PRS is transmitted on a PSFCH: or the SL-PRS is transmitted on both the PSSCH and the PSFCH.

According to some embodiments of the present application, before transmitting the DCI, the network entity may transmit configuration information per resource pool indicating that the SL-PRS can be transmitted on either a PSSCH or a PSFCH. In such embodiments, in the case that the configuration information indicates that the SL-PRS can be transmitted on the PSSCH, the DCI includes a 1-bit indication indicating whether data or the SL-PRS is transmitted on the PSSCH. In the case that the configuration information indicates that the SL-PRS can be transmitted on the PSFCH, the DCI includes a 1-bit indication indicating whether feedback information or the SL-PRS is transmitted on the PSFCH.

According to some other embodiments of the present application, before transmitting the DCI, the network entity may transmit configuration information per resource pool indicating that the SL-PRS can be transmitted on at least one of a PSSCH or a PSFCH. In such embodiments, the DCI may include 2-bit indication indicating that the SL-PRS is transmitted on the PSSCH, the PSFCH or both.

FIG. 14 illustrates a simplified block diagram of an exemplary apparatus 1400 for SL-PRS transmission according to some embodiments of the present application. The apparatus 1400 may be a UE (e.g., a target UE or an anchor UE) or a network entity.

Referring to FIG. 14, the apparatus 1400 may include at least one transmitter 1402, at least one receiver 1404, and at least one processor 1406. The at least one transmitter 1402 is coupled to the at least one processor 1406, and the at least one receiver 1404 is coupled to the at least one processor 1406.

Although in this figure, elements such as the transmitter 1402, the receiver 1404, and the processor 1406 are illustrated in the singular, the plural is contemplated unless a limitation to the singular is explicitly stated. In some embodiments of the present application, the transmitter 1402 and the receiver 1404 may be combined to one device, such as a transceiver. In some embodiments of the present application, the apparatus 1400 may further include an input device, a memory, and/or other components. The transmitter 1402, the receiver 1404, and the processor 1406 may be configured to perform any of the methods described herein (e.g., the method described with respect to any of FIGS. 5-13).

According to some embodiments of the present application, the apparatus 1400 may be a target UE. In some embodiments of the present application, the transmitter 1402 is configured to: transmit SCI, wherein the SCI indicates at least one sidelink resource for transmitting a SL-PRS; and transmit the SL-PRS based on the SCI.

In some embodiments of the present application, the receiver 1404 is configured to receive at least one of: configuration information indicating whether a resource pool used for data transmission can be used for transmitting the SL-PRS; a first indication indicating whether at least one slot of the resource pool can be used for transmitting the SL-PRS: or a second indication indicating whether a RB of the resource pool can be used for transmitting the SL-PRS.

In some embodiments of the present application, the receiver 1404 is configured to receive a configuration information including a first SL-PRS configuration and a second SL-PRS configuration, wherein the first SL-PRS configuration is associated with transmission of the SL-PRS on a PSSCH and the second SL-PRS configuration is associated with transmission of the SL-PRS on a PSFCH; and wherein the SCI includes a 1-bit indication indicating that either the first SL-PRS configuration or the second SL-PRS configuration is used for transmitting the SL-PRS.

In some embodiments of the present application, the SCI includes a 1-bit indication indicating that the SL-PRS is transmitted on either a PSSCH or a PSFCH.

In some embodiments of the present application, the receiver is configured to receive configuration information indicating two of the following three configurations, the SL-PRS can be transmitted on a PSSCH, the SL-PRS can be transmitted on a PSFCH, and the SL-PRS can be transmitted on both the PSSCH and the PSFCH, and wherein the SCI includes a 1-bit indication indicating one of the two configurations is used for transmitting the SL-PRS.

In some embodiments of the present application, the SCI includes a 2-bit indication indicating that: the SL-PRS is transmitted on a PSSCH: the SL-PRS is transmitted on a PSFCH: or the SL-PRS is transmitted on both the PSSCH and the PSFCH.

In some embodiments of the present application, the receiver 1404 is configured to receive configuration information per resource pool indicating that the SL-PRS can be transmitted on either a PSSCH or a PSFCH: wherein in the case that the configuration information indicates that the SL-PRS can be transmitted on the PSSCH, the SCI includes a 1-bit indication indicating whether data or the SL-PRS is transmitted on the PSSCH; and wherein in the case that the configuration information indicates that the SL-PRS can be transmitted on the PSFCH, the SCI includes a 1-bit indication indicating whether feedback information or the SL-PRS is transmitted on the PSFCH.

In some embodiments of the present application, the receiver 1404 is configured to receive configuration information per resource pool indicating that the SL-PRS can be transmitted on at least one of a PSSCH or a PSFCH; and wherein the SCI includes a 2-bit indication indicating that the SL-PRS is transmitted on the PSSCH, the PSFCH or both.

In some embodiments of the present application, the receiver 1404 is configured to receive DCI, and wherein the DCI indicates the at least one sidelink resource for transmitting the SL-PRS; and wherein the processor 1406 is configured to generate the SCI based on the DCI.

In some embodiments of the present application, the receiver 1404 is configured to further receive a configuration information including a first SL-PRS configuration and a second SL-PRS configuration before receiving the DCI, wherein the first SL-PRS configuration indicates that the SL-PRS can be transmitted on a PSSCH and the second SL-PRS configuration indicates that the SL-PRS can be transmitted on a PSFCH; and wherein each of the DCI and the SCI includes a 1-bit indication indicating either the first SL-PRS configuration or the second SL-PRS configuration is applied for transmitting the SL-PRS.

In some embodiments of the present application, each of the DCI and the SCI includes a 1-bit indication indicating that the SL-PRS is transmitted on either a PSSCH or a PSFCH.

In some embodiments of the present application, the receiver 1404 is configured to further receive configuration information before receiving the DCI, and the configuration information indicates two of the following three configurations: the SL-PRS can be transmitted on a PSSCH, the SL-PRS can be transmitted on a PSFCH, and the SL-PRS can be transmitted on both the PSSCH and the PSFCH, and wherein each of the DCI and the SCI includes a 1-bit indication indicating one of the two configurations is used for transmitting the SL-PRS.

In some embodiments of the present application, each of the DCI and the SCI includes a 2-bit indication indicating that: the SL-PRS is transmitted on a PSSCH; the SL-PRS is transmitted on a PSFCH; or the SL-PRS is transmitted on both the PSSCH and the PSFCH.

In some embodiments of the present application, the receiver 1404 is configured to further receive configuration information before receiving the DCI, and the configuration information indicates that the SL-PRS can be transmitted on either a PSSCH or a PSFCH: wherein in the case that the configuration information indicates that the SL-PRS can be transmitted on the PSSCH, each of the DCI and the SCI includes a 1-bit indication indicating whether data or the SL-PRS is transmitted on the PSSCH; and wherein in the case that the configuration information indicates that the SL-PRS can be transmitted on the PSFCH, each of the DCI and the SCI includes a 1-bit indication indicating whether feedback information or the SL-PRS is transmitted on the PSFCH.

In some embodiments of the present application, the receiver 1404 is configured to further receive configuration information per resource pool before receiving the DCI, and the configuration information indicates that the SL-PRS can be transmitted on at least one of a PSSCH or a PSFCH; and wherein each of the DCI and the SCI includes a 2-bit indication indicating that the SL-PRS is transmitted on the PSSCH, the PSFCH or both.

In some embodiments of the present application, the SCI includes a first stage SCI and a second stage SCI.

According to some embodiments of the present application, the apparatus 1400 may be an anchor UE. In some embodiments of the present application, the receiver 1404 is configured to: receive SCI, wherein the SCI indicates at least one sidelink resource for transmitting a SL-PRS; and receive the SL-PRS based on the SCI.

In some embodiments of the present application, the receiver 1404 is configured to further receive at least one of: configuration information indicating whether a resource pool used for data transmission can be used for transmitting the SL-PRS; a first indication indicating whether at least one slot of the resource pool can be used for transmitting the SL-PRS: or a second indication indicating whether a RB of the resource pool can be used for transmitting the SL-PRS.

In some embodiments of the present application, the receiver 1404 is configured to receive a configuration information including a first SL-PRS configuration and a second SL-PRS configuration, wherein the first SL-PRS configuration is associated with transmission of the SL-PRS on a PSSCH and the second SL-PRS configuration is associated with transmission of the SL-PRS on a PSFCH; and wherein the SCI includes a 1-bit indication indicating that either the first SL-PRS configuration or the second SL-PRS configuration is used for transmitting the SL-PRS.

In some embodiments of the present application, the SCI includes a 1-bit indication indicating that the SL-PRS is transmitted on either a PSSCH or a PSFCH.

In some embodiments of the present application, the receiver 1404 is configured to receive configuration information indicating two of the following three configurations: the SL-PRS can be transmitted on a PSSCH, the SL-PRS can be transmitted on a PSFCH, and the SL-PRS can be transmitted on both the PSSCH and the PSFCH, and wherein the SCI includes a 1-bit indication indicating one of the two configurations is used for transmitting the SL-PRS.

In some embodiments of the present application, the SCI includes a 2-bit indication indicating that: the SL-PRS is transmitted on a PSSCH: the SL-PRS is transmitted on a PSFCH: or the SL-PRS is transmitted on both the PSSCH and the PSFCH.

In some embodiments of the present application, the receiver is configured to receive configuration information per resource pool indicating that the SL-PRS can be transmitted on either a PSSCH or a PSFCH; wherein in the case that the configuration information indicates that the SL-PRS can be transmitted on the PSSCH, the SCI includes a 1-bit indication indicating whether data or the SL-PRS is transmitted on the PSSCH; and wherein in the case that the configuration information indicates that the SL-PRS can be transmitted on the PSFCH, the SCI includes a 1-bit indication indicating whether feedback information or the SL-PRS is transmitted on the PSFCH.

In some embodiments of the present application, the receiver is configured to receive configuration information per resource pool indicating that the SL-PRS can be transmitted on at least one of a PSSCH or a PSFCH; and wherein the SCI includes a 2-bit indication indicating that the SL-PRS is transmitted on the PSSCH, the PSFCH or both.

In some embodiments of the present application, wherein the SCI includes a first stage SCI and a second stage SCI.

According to some embodiments of the present application, the apparatus 1400 may be a network entity. In some embodiments of the present application, the transmitter 1402 is configured to transmit DCI, wherein the DCI indicates at least one sidelink resource for transmitting a SL-PRS.

In some embodiments of the present application, the transmitter 1402 is further configured to transmit at least one of: configuration information indicating whether a resource pool used for data transmission can be used for transmitting the SL-PRS; a first indication indicating whether at least one slot of the resource pool can be used for transmitting the SL-PRS; or a second indication indicating whether a RB of the resource pool can be used for transmitting the SL-PRS.

In some embodiments of the present application, the transmitter 1402 is further configured to transmit a configuration information including a first SL-PRS configuration and a second SL-PRS configuration before transmitting the DCI, wherein the first SL-PRS configuration is associated with transmission of the SL-PRS on a PSSCH and the second SL-PRS configuration is associated with transmission of the SL-PRS on a PSFCH; and wherein the DCI includes a 1-bit indication indicating either the first SL-PRS configuration or the second SL-PRS configuration to be used for transmitting the SL-PRS.

In some embodiments of the present application, the DCI includes a 1-bit indication indicating that the SL-PRS is transmitted on either a PSSCH or a PSFCH.

In some embodiments of the present application, the transmitter is further configured to transmit configuration information before transmitting the DCI, and the configuration information indicates two of the following three configurations: the SL-PRS can be transmitted on a PSSCH, the SL-PRS can be transmitted on a PSFCH, and the SL-PRS can be transmitted on both the PSSCH and the PSFCH, and wherein the DCI includes a 1-bit indication indicating one of the two configurations to be used for transmitting the SL-PRS.

In some embodiments of the present application, the DCI includes a 2-bit indication indicating that: the SL-PRS is transmitted on a PSSCH: the SL-PRS is transmitted on a PSFCH: or the SL-PRS is transmitted on both the PSSCH and the PSFCH.

In some embodiments of the present application, the transmitter 1402 is configured to transmit configuration information before transmitting the DCI, and the configuration information indicates that the SL-PRS can be transmitted on either a PSSCH or a PSFCH: wherein in the case that the configuration information indicates that the SL-PRS can be transmitted on the PSSCH, the DCI includes 1-bit indication indicating whether data or the SL-PRS to be transmitted on the PSSCH; and wherein in the case that the configuration information indicates that the SL-PRS can be transmitted on the PSFCH, the DCI includes 1-bit indication indicating whether feedback information or the SL-PRS to be transmitted on the PSFCH.

In some embodiments of the present application, the transmitter 1402 is further configured to transmit configuration information per resource pool before transmitting the DCI, and the configuration information indicates that the SL-PRS can be transmitted on at least one of a PSSCH or a PSFCH; and wherein the DCI includes a 2-bit indication indicating whether the SL-PRS is transmitted on the PSSCH, the PSFCH or both.

In some embodiments of the present application, the apparatus 1400 may further include at least one non-transitory computer-readable medium. In some embodiments of the present disclosure, the non-transitory computer-readable medium may have stored thereon computer-executable instructions to cause the processor 1406 to implement any of the methods as described above. For example, the computer-executable instructions, when executed, may cause the processor 1406 to interact with the transmitter 1402 and/or the receiver 1404, so as to perform operations of the methods, e.g., as described with respect to FIGS. 5-13.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL-PRS transmission, including a processor and a memory. Computer programmable instructions for implementing a method for SL-PRS transmission are stored in the memory, and the processor is configured to perform the computer programmable instructions to implement the method for SL-PRS transmission. The method for SL-PRS transmission may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory. EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL-PRS transmission according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
transmit sidelink control information (SCI), wherein the SCI indicates at least one sidelink resource for transmitting a sidelink positioning reference signal (SL-PRS); and
transmit the SL-PRS based on the SCI.

2. The UE of claim 1, wherein the at least one processor is further configured to cause the UE to:
receive configuration information indicating whether a resource pool used for data transmission can be used for transmitting the SL-PRS;
receive a first indication indicating whether at least one slot of the resource pool can be used for transmitting the SL-PRS; or
receive a second indication indicating whether a resource block (RB) of the resource pool can be used for transmitting the SL-PRS.

3. The UE of claim 1, wherein the at least one processor is further configured to cause the UE to receive a configuration information including a first SL-PRS configuration and a second SL-PRS configuration, wherein the first SL-PRS configuration is associated with transmission of the SL-PRS on a physical sidelink shared channel (PSSCH) and the second SL-PRS configuration is associated with transmission of the SL-PRS on a physical sidelink feedback channel (PSFCH); and
wherein the SCI includes a 1-bit indication indicating that either the first SL-PRS configuration or the second SL-PRS configuration is used for transmitting the SL-PRS.

4. The UE of claim 1, wherein the SCI includes a 1-bit indication indicating that the SL-PRS is transmitted on either a physical sidelink shared channel (PSSCH) or a physical sidelink feedback channel (PSFCH).

5. The UE of claim 1, wherein the at least one processor is further configured to cause the UE to receive configuration information indicating two of three configurations that include the SL-PRS can be transmitted on a physical sidelink shared channel (PSSCH), the SL-PRS can be transmitted on a physical sidelink feedback channel (PSFCH), and the SL-PRS can be transmitted on both the PSSCH and the PSFCH, and wherein the SCI includes a 1-bit indication indicating one of the two configurations is used for transmitting the SL-PRS.

6. The UE of claim 1, wherein the SCI includes a 2-bit indication indicating that: the SL-PRS is transmitted on a physical sidelink shared channel (PSSCH); the SL-PRS is transmitted on a physical sidelink feedback channel (PSFCH); or the SL-PRS is transmitted on both the PSSCH and the PSFCH.

7. The UE of claim 1, wherein the at least one processor is further configured to cause the UE to receive configuration information per resource pool indicating that the SL-PRS can be transmitted on either a physical sidelink shared channel (PSSCH) or a physical sidelink feedback channel (PSFCH);
wherein in a case that the configuration information indicates that the SL-PRS can be transmitted on the PSSCH, the SCI includes a 1-bit indication indicating whether data or the SL-PRS is transmitted on the PSSCH; and
wherein in a case that the configuration information indicates that the SL-PRS can be transmitted on the PSFCH, the SCI includes a 1-bit indication indicating whether feedback information or the SL-PRS is transmitted on the PSFCH.

8. The UE of claim 1, wherein the at least one processor is further configured to cause the UE to receive configuration information per resource pool indicating that the SL-PRS can be transmitted on at least one of a physical sidelink shared channel (PSSCH) or a physical sidelink feedback channel (PSFCH); and
wherein the SCI includes a 2-bit indication indicating that the SL-PRS is transmitted on the PSSCH, the PSFCH or both.

9. The UE of claim 1, wherein the at least one processor is further configured to cause the UE to:
receive downlink control information (DCI), and wherein the DCI indicates the at least one sidelink resource for transmitting the SL-PRS.

10. The UE of claim 9, wherein the at least one processor is further configured to cause the UE to receive a configuration information including a first SL-PRS configuration and a second SL-PRS configuration before receiving the DCI, wherein the first SL-PRS configuration indicates that the SL-PRS can be transmitted on a physical sidelink shared channel (PSSCH) and the second SL-PRS configuration indicates that the SL-PRS can be transmitted on a physical sidelink feedback channel (PSFCH); and
wherein each of the DCI and the SCI includes a 1-bit indication indicating either the first SL-PRS configuration or the second SL-PRS configuration is applied for transmitting the SL-PRS.

11. The UE of claim 9, wherein each of the DCI and the SCI includes a 1-bit indication indicating that the SL-PRS is transmitted on either a PSSCH or a PSFCH.

12. The UE of claim 9, wherein the at least one processor is further configured to cause the UE to receive configuration information before receiving the DCI, wherein the configuration information indicates two of three configurations that include the SL-PRS can be transmitted on a physical sidelink shared channel (PSSCH), the SL-PRS can be transmitted on a physical sidelink feedback channel (PSFCH), and the SL-PRS can be transmitted on both the PSSCH and the PSFCH, and wherein each of the DCI and the SCI includes a 1-bit indication indicating one of the two configurations is used for transmitting the SL-PRS.

13. The UE of claim 9, wherein each of the DCI and the SCI includes a 2-bit indication indicating that: the SL-PRS is transmitted on a physical sidelink shared channel (PSSCH); the SL-PRS is transmitted on a physical sidelink feedback channel (PSFCH); or the SL-PRS is transmitted on both the PSSCH and the PSFCH.

14. A user equipment (UE), comprising:
at least one memory; and
at least one processor coupled with the at least one memory and configured to cause the UE to:
receive sidelink control information (SCI), wherein the SCI indicates at least one sidelink resource for transmitting a sidelink positioning reference signal (SL-PRS); and
receive the SL-PRS based on the SCI.

15. A base station for wireless communication, comprising:
at least one memory; and
at least one processor coupled with the at least one memory and configured to cause the base station to:
transmit downlink control information (DCI), wherein the DCI indicates at least one sidelink resource for transmitting a sidelink positioning reference signal (SL-PRS).

16. A processor for wireless communication, comprising:
at least one controller coupled with at least one memory and configured to cause the processor to:
transmit sidelink control information (SCI), wherein the SCI indicates at least one sidelink resource for transmitting a sidelink positioning reference signal (SL-PRS); and
transmit the SL-PRS based on the SCI.

17. The processor of claim 16, wherein the at least one controller is further configured to cause the processor to:
receive configuration information indicating whether a resource pool used for data transmission can be used for transmitting the SL-PRS;
receive a first indication indicating whether at least one slot of the resource pool can be used for transmitting the SL-PRS; or
receive a second indication indicating whether a resource block (RB) of the resource pool can be used for transmitting the SL-PRS.

18. The processor of claim 16, wherein the at least one controller is further configured to cause the processor to receive a configuration information including a first SL-PRS configuration and a second SL-PRS configuration, wherein the first SL-PRS configuration is associated with transmission of the SL-PRS on a physical sidelink shared channel (PSSCH) and the second SL-PRS configuration is associated with transmission of the SL-PRS on a physical sidelink feedback channel (PSFCH); and
wherein the SCI includes a 1-bit indication indicating that either the first SL-PRS configuration or the second SL-PRS configuration is used for transmitting the SL-PRS.

19. The processor of claim 16, wherein the SCI includes a 1-bit indication indicating that the SL-PRS is transmitted on either a physical sidelink shared channel (PSSCH) or a physical sidelink feedback channel (PSFCH).

20. The processor of claim 16, wherein the at least one controller is further configured to cause the processor to receive configuration information indicating two of three configurations that include the SL-PRS can be transmitted on a physical sidelink shared channel (PSSCH), the SL-PRS can be transmitted on a physical sidelink feedback channel (PSFCH), and the SL-PRS can be transmitted on both the PSSCH and the PSFCH, and wherein the SCI includes a 1-bit indication indicating one of the two configurations is used for transmitting the SL-PRS.
